(19) United States
(12) Patent Application Publication
(10) Pub. No.: US 2011/0151926 A1
(43) Pub. Date: Jun. 23, 2011

(54) METHOD AND SYSTEM FOR CONTROLLING OUTPUT OF A MOBILE DEVICE

(75) Inventors: Hee Woon KIM, Suwon-si (KR); Si Hak JANG, Yongin-si (KR)

(73) Assignee: SAMSUNG ELECTRONICS CO. LTD., Suwon-si (KR)

(21) Appl. No.: 12/964,244

(22) Filed: Dec. 9, 2010

(30) Foreign Application Priority Data
Dec. 17, 2009 (KR) 10-2009-0126290

(51) Int. Cl. H04W 88/02

(52) U.S. Cl. 455/556.1

(57) ABSTRACT

A method and system for controlling an external output function of a mobile device are provided. The method and system can adaptively control the external output function according to a user's gesture-based interaction transferred from a sensor module when the projector module of the mobile device outputs screen data to an external screen. The method includes outputting an external output from the projector module to an external screen, activating a sensor module, detecting, by the sensor module, an interaction according to a user's gesture, and controlling the external output, based on the detected interaction.

### PRIORITY

This application claims the benefit under 35 U.S.C. §119(a) of a Korean patent application filed on Dec. 17, 2009 in the Korean Intellectual Property Office and assigned Serial No. 10-2009-0126290, the entire disclosure of which is hereby incorporated by reference.

### BACKGROUND OF THE INVENTION

1. Field of the Invention

The present invention relates to electronic systems. More particularly, the present invention relates to a method and system that can control screen data output from a projector module installed in a mobile device, according to a user's gesture-based interactions detected by a sensor module.

2. Description of the Related Art

With advancements in digital technology, a variety of mobile devices have been released that can perform communication and can process a user's information while moving. Examples of such mobile devices include a mobile communication device, a Personal Digital Assistant (PDA), an electronic organizer, etc. These mobile devices output screen data on their display units. In general, the display units provided to the mobile devices are relatively small, because the mobile devices themselves are manufactured to be small.

Frequently, a user will show information to other people via the display unit of his/her mobile device. In that case, the users have difficulty viewing the information together because the display unit is small. To resolve this problem, in recent years, mobile devices have been developed to be equipped with a TeleVision (TV)-Out function that can output information from the mobile devices to an external display system, so that people can more easily view the information. However, to this end, the users of the mobile devices require the external display system and connection thereto via an additional connector.

To resolve the problem requiring the external display system, some mobile devices have been developed to have a projection function that can project a large screen onto an external screen, for example, a projector unit. In that case, the mobile device can output screen data on an external screen, such as a wall, floor, etc., via the projector unit. A mobile device with a projection function can output screen data, appearing on the display unit, to the external screen.

The mobile device with a projector unit can be controlled by a wireless control unit, separated from the mobile devices, or by a mechanical force applied to a control input (e.g., a button, a touch screen, or the like) installed to the mobile device.

In order to control the mobile device with a projector unit, when a user applies a mechanical touch to the body of the mobile device, the mobile device may be displaced. When the mobile device outputting screen data to the external screen in a user's set direction and angle is displaced, the screen data is also displaced and varies in position on the external screen. For example, when a movement occurs while the mobile device is showing a presentation or a movie on an external screen, the user must operate the mobile device to correct for the movement. This may cause a disturbance in showing of the presentation or the movie. The conventional mobile device with a projection function requires the user to re-adjust the position of the mobile device or re-set the options of the projection function in order to correct for the movement.

In particular, when the mobile device employs the wireless control unit, the user must carry the wireless control unit as well.

### SUMMARY OF THE INVENTION

An aspect of the present invention is to address at least the above-mentioned problems and/or disadvantages and to provide at least the advantages described below. Accordingly, an aspect of the present invention is to provide a method and system that can control a mobile device that is equipped with a projector module that receives screen data and outputs it to an external screen and that can control the output of the projector module.

Another aspect of the present invention is to provide a method and system that can adaptively control the screen data, output from a projector module installed to a mobile device, according to a user's environment.

Yet another aspect of the present invention is to provide a method and system that can simply and efficiently control the screen data output from a projector module installed to a mobile device, without mechanically touching the mobile device.

Still another aspect of the present invention is to provide a method and system that can control screen data output from a projector module installed to a mobile device, according to a user's gesture-based interactions detected by a sensor module.

Another aspect of the present invention is to provide a method and system that can precisely and efficiently control the screen data output from a projector module installed to a mobile device, in a dark environment, using a proximity sensor.

Yet another aspect of the present invention is to provide a method and system that can simply and efficiently control the screen data output from a projector module installed to a mobile device, in a bright environment, using a camera sensor.

Still another aspect of the present invention is to provide a method and system that can adaptively control the screen data output from a projector module installed to a mobile device, according to an external environment.

In accordance with an aspect of the present invention, a method for controlling a mobile device equipped with a projector module is provided. The method includes, outputting an external output from the projector module to an external screen, activating a sensor module, detecting, by the sensor module, an interaction according to a user's gesture, and controlling the external output based on the interaction.

In accordance with another aspect of the present invention, a mobile device is provided. The device includes a projector module for outputting screen data of the mobile device to an external screen, a storage unit for storing optional information for an external output function of the mobile device, a sensor module for detecting a user's gesture performed in proximity to the mobile device and providing an interaction corresponding to the user's gesture, and a controller. The controller controls a function related to an external output of the projector module. The controller also controls the external output function according to the optional information when detecting the interaction transferred from the sensor module while the external output is being output.

In accordance with an aspect of the present invention, the proximity detecting module includes at least one of a proximity sensor and an illumination sensor. And, the proximity sensor comprises a plurality of proximity sensors oriented in mutually different directions, and the illumination sensor comprises a plurality of illumination sensors oriented in mutually different directions.

In accordance with an aspect of the present invention, the camera module comprises a plurality of cameras oriented in mutually different directions.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a bar type of mobile device with a full touch screen, according to an exemplary embodiment of the present invention;

FIG. 2 illustrates a bar type of mobile device with a display unit and an input unit which are sectioned on a front side of the mobile device according to an exemplary embodiment of the present invention;

FIG. 3 illustrates a schematic block diagram of a mobile device according to an exemplary embodiment of the present invention;

FIG. 4 illustrates views that describe methods for activating a mode and displaying a virtual item in a mobile device, according to an exemplary embodiment of the present invention;

FIG. 5 illustrates views that describe a method for controlling an external output in a mobile device, after activating a mode, according to an exemplary embodiment of the present invention;

FIG. 6 illustrates views that describe a method for controlling an external output in a mobile device, without activating a mode, according to an exemplary embodiment of the present invention;

FIG. 7 illustrates a flow chart that describes a method for controlling an external output in a mobile device, by detecting a user's gesture, according to an exemplary embodiment of the present invention; and

FIG. 8 illustrates views that describe a method for controlling an external output, based on a mode set in a mobile device, according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the exemplary embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention relate to a method and system for controlling an external output of a mobile device with a projection function. In particular, exemplary embodiments of the present invention relate to a method and system that can simply control an external output function of the mobile device, according to a user's gesture detected by a sensor module, corresponding to a user's environment, when the mobile device outputs screen data to an external screen through the projection function.

In the method and system, a user's gesture-based interaction is received from a sensor module corresponding to a user's environment (e.g., a dark or bright place) when the mobile device outputs screen data, and the external output of the mobile device is controlled, according to the received interaction. In the method and system, a user's gesture via the sensor module is detected, and screen data being output to the external screen is adaptively controlled based on the detected user's gesture, according to the user's environment.

The mobile device of an exemplary embodiment of the present invention includes a projector module and a sensor module for detecting a user's gesture when the projector module outputs screen data. The sensor module includes a proximity detecting module and a camera module. The proximity detecting module includes a proximity sensor, an illumination sensor, etc.

The following description illustrates the configuration of the mobile device with a projector module according to an exemplary embodiment of the present invention. It should be understood that the invention is not limited to the exemplary embodiment. It will be noted that there may be many modifications from the exemplary embodiments without departing from the scope or spirit of the invention.

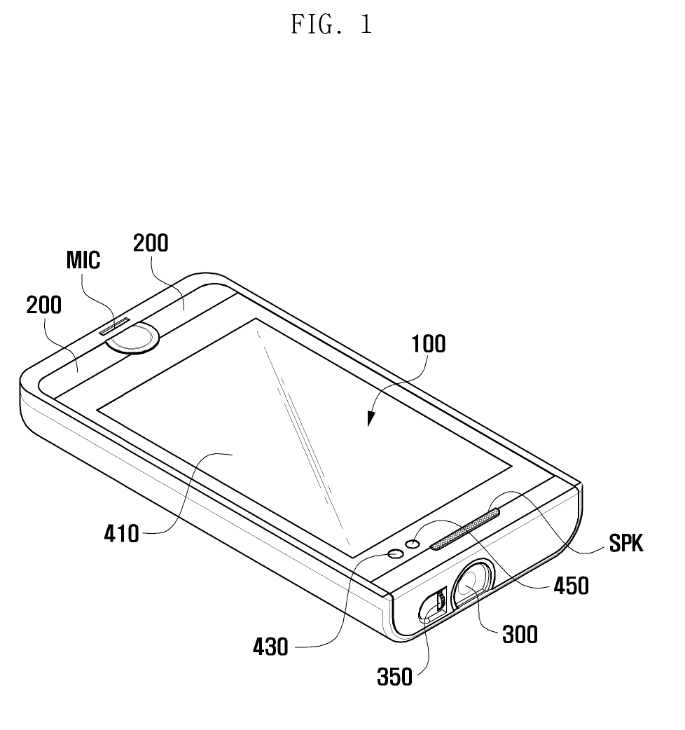

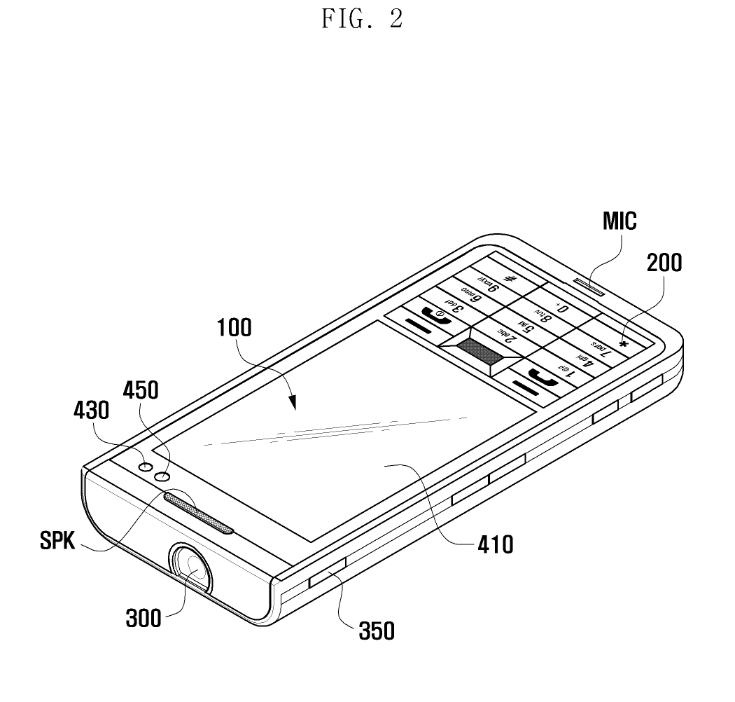

FIGS. 1 and 2 illustrate exemplary implementations of the mobile device according to an exemplary embodiment of the present invention. FIG. 1 illustrates a bar type of mobile device with a full touch screen, according to an exemplary embodiment of the present invention, and FIG. 2 illustrates a bar type of mobile device with a display unit and an input unit, according to an exemplary embodiment of the present invention.

Referring to FIGS. 1 and 2, the mobile device includes a display unit 100 for displaying screen data according to the execution of a corresponding function, an input unit 200 for receiving a user's input, a projector module 300 for enlarging and projecting screen data to an external screen, a focus control unit 350 for controlling the focus of the projector module 300, a speaker SPK for outputting various types of audio signals according to the execution of a corresponding function, a microphone MIC for receiving external audio signals such as a user's voice, etc., and a sensor module 400 (not shown in FIGS. 1-2).

In an exemplary embodiment of the present invention, the sensor module 400 includes a proximity detecting module 420 (not shown in FIGS. 1-2) and a camera module 430. The proximity detecting module 420 includes a proximity sensor 410 and an illumination sensor 450. The proximity sensor 410 is installed in the mobile device. The proximity sensor 410 detects a user's gesture performed near the mobile device and provides an interaction corresponding thereto. The camera module 430 can capture visual images of a user or other subjects in a video communication mode. The camera module 430 can also detect a user's gesture in a user's gesture detecting mode and can provide an interaction corresponding thereto. The illumination sensor 450 detects a user's gesture performed near the mobile device and provides an interaction corresponding thereto.

The sensor module 400 may further include all types of sensors that can track user's gestures and create values corresponding to the user's gestures. Although in an exemplary embodiment of the invention the sensor module 400 is installed in the mobile device as shown in FIGS. 1 and 2, it should be understood that the invention is not limited to the exemplary embodiment. For example, the sensor module 400 can be installed in a variety of locations in mobile devices depending on the types of mobile devices. Although the mobile devices shown in FIGS. 1 and 2 are implemented to include the proximity sensor 410, camera module 430, and illumination sensor 450, it should be understood that the invention is not limited to the exemplary embodiment. That is, the mobile device can be implemented, for example, to include only one of them. For example, when the sensor module 400 for detecting a user's gesture and controlling an external output is operated by the proximity sensor 410, the mobile device can include either the camera module 430 and the illumination sensor 450, or neither of them (430, 450). The sensor module 400 can be implemented with various types of sensors according to types of mobile devices.

The sensor module 400 can be configured by a combination of the proximity sensor 410, the camera module 430, and the illumination sensor 450: The sensor module 400 can also be configured by a combination of the proximity sensor 410 and the illumination sensor 450, the proximity sensor 410 and the camera module 430, or the camera module 430 and the illumination sensor 450. The sensor components configuring the sensor module 400 are installed in the mobile device in order to control the external output.

In addition, each sensor component (i.e., the proximity sensor 410, the camera module 430, and the illumination sensor 450) can be formed with a number of same sensor components. For example, the same proximity sensor 410 can be installed to four sides of the mobile device with respect to the front side, i.e., top, bottom, right, and left. In that case, the four proximity sensors 410 are called a multi-proximity sensor. Likewise, the same illumination sensor 450 can be installed to four sides of the mobile device with respect to the front side, i.e., top, bottom, right, and left. In that case, the four illumination sensors 450 are called a multi-illumination sensor. As another example of the arrangement, the same proximity sensor 410 can be installed to two sides of the mobile device with respect to the front side, i.e., right and left. In that case, the two proximity sensors 410 are also called a multi-proximity sensor. Likewise, the same illumination sensor 450 can be installed to two sides of the mobile device with respect to the front side, i.e., top and bottom. In that case, the two proximity sensors 410 are also called a multi-proximity sensor.

As described above, the mobile device can be configured to include a number of identical or different types of sensor components so that it can precisely and correctly detect various types of user's gestures via the sensor components. For example, when the sensor components forming the sensor module 400 are installed to up, bottom, right and left sides of the mobile device, the mobile device can more precisely detect a user's gesture, including the proceeding direction of the gesture.

For example, as shown in FIG. 1, when the user views the mobile device from the direction of microphone MIC and his/her gesture is performed from the left to the right, the mobile device can sense that an object (e.g., the user's hand) approaches to the mobile device via the left sensor module (or a left sensor component) and, after a period of time (e.g., n seconds, where n is an integer) has elapsed, can sense the object via the right sensor module (or a right sensor component). In that case, the mobile device can calculate the detecting time difference between the left and right sensor modules, based on the distance between the left and right sensor modules, and can determine the direction and speed of the movement of the object.

In an exemplary embodiment of the present invention, although the mobile device with a projector module according to the invention is described based on a bar type as shown in FIGS. 1 and 2, it will be appreciated that the invention can also be applied to all types of mobile devices, for example, a folder type, a slide type, a flip-flop type, etc. The features and operations of the mobile device described herein can be applied to all information communication devices, multimedia devices, and their applications, if they can control an external output function according to the operation of the sensor module 400. For example, the features and operations of the mobile device described herein can be applied to all types of mobile communication terminals that are operated according to communication protocols corresponding to a variety of communication systems and also to relatively small-sized devices, for example, a Portable Multimedia Player (PMP), a digital broadcast player, a Personal Digital Assistant (PDA), an audio player (e.g., MP3 player), a mobile game player, a smart phone, etc. The features and operations of the mobile device described herein can also be applied to relatively mid- and large-sized devices, for example, a television set, a Large Format Display (LFD), a Digital Signage (DS), a media pole, a personal computer, a laptop computer, etc.

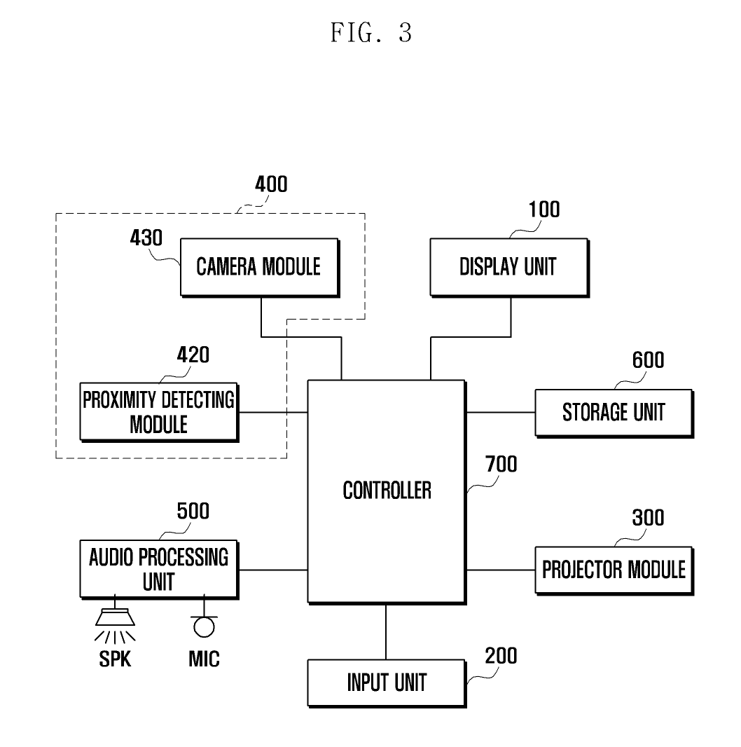

The following description explains the elements of the mobile device with a projector module, with reference to FIG. 3. It will be described in such a way that the sensor module installed to the mobile device includes a proximity sensor 410 and a camera module 430.

FIG. 3 illustrates a schematic block diagram of a mobile device according to an exemplary embodiment of the present invention.

Referring to FIG. 3, the mobile device includes an input unit 200, an audio processing unit 500, a display unit 100, a storage unit 600, a projector module 300, a sensor module 400, and a controller 700.

The input unit 200 outputs input signals corresponding to numerical and text information, signals for setting functions of the mobile device, and control signals related to the function to the controller 700. The input unit 200 creates command signals related to the entire operation of the mobile device. The input unit 200 may include function keys and input keys for creating the signals. The function keys may include direction keys, side keys, shortcut keys, etc., which are set to perform specific functions (e.g., a projection function). In addition, the input unit 120 may further include a focus adjustment unit 350 for adjusting the focus of the projector module 300 as shown in FIGS. 1 and 2.

The input unit 200 may be implemented, for example, by one of a touch pad, a touch screen, a keypad of a general key arrangement (e.g., 3×4 or 4×3 key arrangement), a QWERTY keypad, a dome key, or a combination thereof. In particular, the input unit 200 creates an input signal for executing a projection function and outputs it to the controller 700. The input signal for executing a projection function may be a key signal created by operating the input unit 200. Alternatively, if the mobile device is equipped with a touch screen, the input signal for executing a projection function may be created by touching the touch screen.

The audio processing unit 500 includes a speaker SPK for reproducing audio signals from the mobile device, and a microphone MIC for receiving audio input signals, for example, a user's voice. The audio processing unit 500 connects to the speaker SPK and the microphone MIC. The audio processing unit 500 converts audio signals, received by the microphone MIC, into digital data and then outputs the data to the controller 700. The audio processing unit 500 also receives audio signals from the controller 700 and outputs them via the speaker SPK. The audio processing unit 500 can also output various types of audio signals created in the mobile device, according to the user's selection. The audio signals may include signals created as video or audio data is reproduced, a signal for generating an alarm sound according to the execution of the projection function, etc.

The display unit 100 outputs various types of screens when corresponding functions are performed in the mobile device. For example, the display unit 100 can display a booting screen, an idle screen, a menu screen, a list screen, a playback screen, application executing screens of the mobile device, etc. The display unit 100 displays screen data related to the states and operations of the mobile device. The display unit 100 can also display signals and color information output from the controller 700. The display unit 100 can be implemented, for example, with a Liquid Crystal Display (LCD), a Plasma Display Panel (PDP), a Light Emitting Diode (LED), an Organic LED (OLED), an Active Matrix OLED (AMOLED), or the like. If the display unit 100 is implemented with a touch screen, then it can also serve as an input device. In that case, the mobile device according to the invention can be configured without a separate input unit 200.

When the mobile device performs the projection function, the display unit 100 displays screen data, output from the controller 700, or a particular Graphic User Interface (GUI) for controlling the external output function of the mobile device. That is, when the mobile device performs the projection function, the display unit 100 can display screen data that either is identical to or differs from the screen data output to the external screen, according to the control of the controller 700. It is assumed for this description that the screen data displayed on the display unit 100 is called ‘internal screen data’ and the screen data displayed on the external screen is called ‘external screen data.’ For example, the display unit 100 can display GUI serving as a virtual item for controlling the external output function, on an image corresponding to the internal screen data, according to the control of the controller 700.

The storage unit 600 stores data created or used in the mobile device. The data refers to all data that are created by the mobile device or received from external systems (e.g., other external mobile devices, personal computers, etc.). Examples of the data may include video data, audio data, broadcast data, photograph data, message data, text data, image data, etc. The storage unit 600 can store applications for executing corresponding functions in the mobile device. An example of an application is to execute a projection function in the mobile device. The storage unit 600 can store a virtual item for controlling a projection function when the projection function is activated. The storage unit 600 can also store software for controlling a function of screen data that the projector module 300 is currently outputting to an external screen.

The storage unit 600 stores the optional information for the external output function of the mobile device. The optional information may include control information, for determining whether to control a function according to an interaction without a mode activation procedure, or without displaying a virtual item, when the interaction occurs during the external output; display information, for setting a display mode of a virtual item for controlling a function of the screen data that is output to an external screen according to the execution of a particular application; mapping information regarding virtual items mapped by applications; and function information corresponding to mapping information by applications. When the mobile device outputs screen data of a particular application on an external screen and creates a virtual item for controlling the external output function, the display information, serving as setting information, is used, for example, to set displaying of the virtual item on both the screen data displayed on the external screen, which is called external screen data, and the screen data displayed on the display unit 100, which is called internal screen data; displaying the virtual item on only the external screen data; displaying the virtual item on only the internal screen data; and not displaying the virtual item.

The storage unit 600 includes at least one or more buffers that temporarily store data generated while a function of the mobile device is executed. For example, the storage unit 600 buffers screen data that is output to an external screen via the projector module 300.

The storage unit 600 may also be implemented with all types of recoding media that can be installed inside or outside the mobile device, for example, a smart card. The storage unit 600 may include Random Access Memory (RAM), Read Only Memory (ROM), or flash memory, or a combination thereof. The storage unit 600 may include one or two integrated memory, for example, Multi-Chip Package (MCP) memory, etc.

The projector module 300 can be internally or externally installed to the mobile device. The projector module 300 outputs screen data provided by the controller 700 to an external screen via a lens (not shown). The projector module 300 can project screen data processed by the controller 700 to an external screen without distortion.

The sensor module 400 detects a user's gestures (e.g., the movement direction of the user's hand, the user's hand motion, the user's hand shape, etc.) performed near the mobile device, and transfers values corresponding to the detected user's gestures to the controller 700. The value corresponding to a user's gesture, detected by the sensor module 400, is used to determine the movement direction and speed of the user's gesture and the shape of the user's gesture (e.g., a user's hand shape, etc.).

The sensor module 400 detects a user's gesture performed in a space near the mobile device and serves to create an interaction corresponding thereto. The sensor module 400 can be operated when the projector module 300 is driven or according to a user's selection. The sensor module 400 detects a user's gesture when the projector module 300 outputs screen data to an external screen, creates interaction information and transfers it to the controller 700. The sensor module 400 uses at least one of the proximity detecting module 420 and the camera module 430.

The proximity detecting module 420 may include at least one of a proximity sensor 410 and an illumination sensor 450. In the following description, the proximity detecting module 420 is implemented with a proximity sensor 410. The proximity detecting module 420 detects a user's gesture performed in space near the mobile device. When the mobile device performs an external output function based on the projector module 300, the proximity detecting module 420 tracks a state where an object (e.g., a user's hand) approaches the mobile device, which is called proximity information, and the movement of the object, which is called change information, creates a value based on the track result, and transfers the value to the controller 700. That is, the proximity detecting module 420 detects an interaction corresponding to a user's gesture performed in space near the mobile device and transfers the result according to the interaction to the controller 700.

The camera module 430 captures a visual image of a subject under the control of the controller 700 and transfers the captured data to the display unit 100 and the controller 700. The camera module 430 allows a light sensor to convert light received via the lens into digital data. The camera module 430 includes a camera sensor (not shown) for converting received light into electrical signals, and a signal processing unit (not shown) for converting the electrical signals, output from the camera sensor, into digital data. The camera sensor may be, for example, a Charge-Coupled Device (CCD), a Complementary Metal-Oxide-Semiconductor (CMOS), etc.

The camera module 430 detects a user's gesture performed in space near the mobile device. When the mobile device performs an external output function based on the projector module 300, the camera module 430 detects that an object (e.g., a user's hand) enters in its capture range, which is called proximity information, tracks the movement of the object, which is called change information, creates a value based on the track result, and transfers the value to the controller 700. That is, the camera module 430 detects an interaction corresponding to a user's gesture performed in the capture range and transfers the result according to the interaction to the controller 700. When an external output operation is performed according to a projection function, the data transferred from the camera module 430 is not displayed on the display unit 100 (e.g., a preview is not displayed). That is, the data detected by the camera module 430 while performing the projection function is processed as a background data, i.e., the data is used only as information for detecting a user's gesture.

Although detecting a user's gesture for controlling an external output function of the mobile device is described based on the proximity detecting module 420 and the camera module 430 shown in FIG. 3, it should be understood that the invention is not limited to the exemplary embodiment. The mobile device can also receive input information for controlling the external output function via, for example, a touch pad, a touch screen, a microphone, etc. For example, the mobile device can receive, as input information, at least one of the touch information via a touch pad or a touch screen, and the voice information via a microphone, and can create a control signal according to the input information. After that, the mobile device can control the external output function based on the created control signal.

The controller 700 controls the entire operation of the mobile device and also controls signals flowing among the elements in the mobile device. Examples of the elements are the input unit 200, audio processing unit 500, display unit 100, storage unit 600, projector module 300, and sensor module 400 (proximity detecting module 420 and camera module 430).

The controller 700 controls an external output via the projector module 300 and also controls an external output function according to interaction information transferred from the sensor module 400 (proximity detecting module 420 and camera module 430). That is, the controller 700 processes a user's gesture, detected by the sensor module 400, as an input of an interaction for controlling functions of the mobile device, and controls an external output function corresponding to the user's gesture.

The controller 700 outputs the screen data via the display unit 100, which in this description is referred to as an internal screen data, and also the screen data via the projector module 300, which in this description is referred to as an external screen data, when the mobile device performs the projection function. In particular, when the projector module 300 outputs the screen data of a particular application on an external screen, the controller 700 may turn off the display unit 100 or may not display the internal screen data on the display unit 100. Alternatively, the controller 700 can display the same screen data on both the display unit 100 and on the external screen. In that case, the internal screen data is identical to the external screen data. In addition, the controller 700 can also display different screen data on the display unit 100 and the external screen. In that case, the internal screen data differs from the external screen data. For example, the internal screen data as a User Interface (UI) provided by the mobile device can be displayed on the entire screen. The external screen data can be displayed in such a way that corresponding screen data, reproduced/executed according to an application, is enlarged and then output to an external screen.

When an external output function is performed based on the projector module 300, the controller 700 receives interaction information from the sensor module 400 and checks preset optional information. The controller 700 determines whether to activate a mode, i.e., whether to display a virtual item, according to the control information of the optional information. When activating a mode based on the control information, the controller 700 outputs the virtual item for controlling a function, i.e., an intuitive GUI, to at least one of the internal screen data on the display unit 100 and the external screen data on the external screen.

The controller 700 can output the virtual item to at least one of the internal screen data and the external screen data, according to the display information from among the preset optional information. That is, the controller 700 receives the interaction information from the sensor module 400 and determines whether to activate a mode according to the control information. The controller 700 outputs a virtual item in the activated mode and then waits for new interaction information from the sensor module 400. The controller 700 receives new interaction information from the sensor module 400 and then controls an external output according to the new interaction information.

The controller 700 receives first information (the initially detected interaction information) from the sensor module 400 during the external output and then controls the output of a virtual item, according to the display information, in an external output control mode. In addition, the controller 700 receives second information (new interaction information transferred from the sensor module 400, after the mode is activated) from the sensor module 400 in a state where the virtual item is output, and then controls an external output function according to the second information.

For example, the controller 700 receives first information corresponding to a user's gesture from the sensor module 400 while the projector module 300 is outputting broadcast data to an external screen, and then outputs a virtual item to at least one of the internal screen data and the external screen data. After that, the controller 700 receives second information corresponding to a user's gesture from the sensor module 400, and then controls the increase/decrease of volume, channel switch, Fast Forward (FF), REWind (REW), pause, playback, page switch, image switch, slide show, etc., according to the second information.

When the controller 700 performs an external output function based on the projector module 300, it receives interaction information from the sensor module 400 and checks preset optional information. The controller 700 determines whether to activate a mode, i.e., whether to display a virtual item, according to the control information of the optional information. When not activating a mode based on the control information, the controller 700 controls an external output function, without outputting the virtual item, according to the interaction information transferred from the sensor module 400. That is, the controller 700 can control an external output function, according to corresponding to interaction information, without activating the mode.

The control operations of the controller 700 are described, in detail further below, with reference to the accompanying drawings. As described above, the controller 700 can control the entire operation related to an external output function when the projector module 300 is operated. In should be understood that the control operation of the controller 700 can also be implemented with software having an algorithm.

In an exemplary embodiment of the invention, although FIGS. 1 and 3 schematically show the configuration of the mobile device, it should be understood that the invention is not limited to the exemplary embodiment.

The controller 700 may include a baseband module for allowing the mobile device to provide a mobile communication service. In that case, the mobile device may further include a Radio Frequency (RF) communication module for establishing a communication channel with a mobile communication system and for allowing the mobile device to communicate with the mobile communication system. Although it is not shown in FIGS. 1 to 3, the mobile device may further include a location information receiver for acquiring location information about the mobile device, such as Global Positioning System (GPS), a Bluetooth communication module for supporting Bluetooth communication, interface units for transmitting and receiving data in wired or wireless mode of the mobile device, an Internet communication module for supporting an Internet function via the Internet, a digital broadcast module for receiving and reproducing digital broadcasts, etc. In another exemplary embodiment, it will be appreciated that the mobile device may be implemented by omitting a particular element from the configuration shown in FIGS. 1 to 3 or by replacing it with other elements.

The foregoing description explained the configuration of the mobile device according to an exemplary embodiment of the present invention. The following description explains the operations of the mobile device with a projection function and the method for controlling the external output function based on the projector module 300 with reference to the accompanying drawings. It should be, however, understood that the invention is not limited to the following exemplary embodiment. It will be noted that there may be many modifications from the exemplary embodiments without departing from the scope or spirit of the present invention.

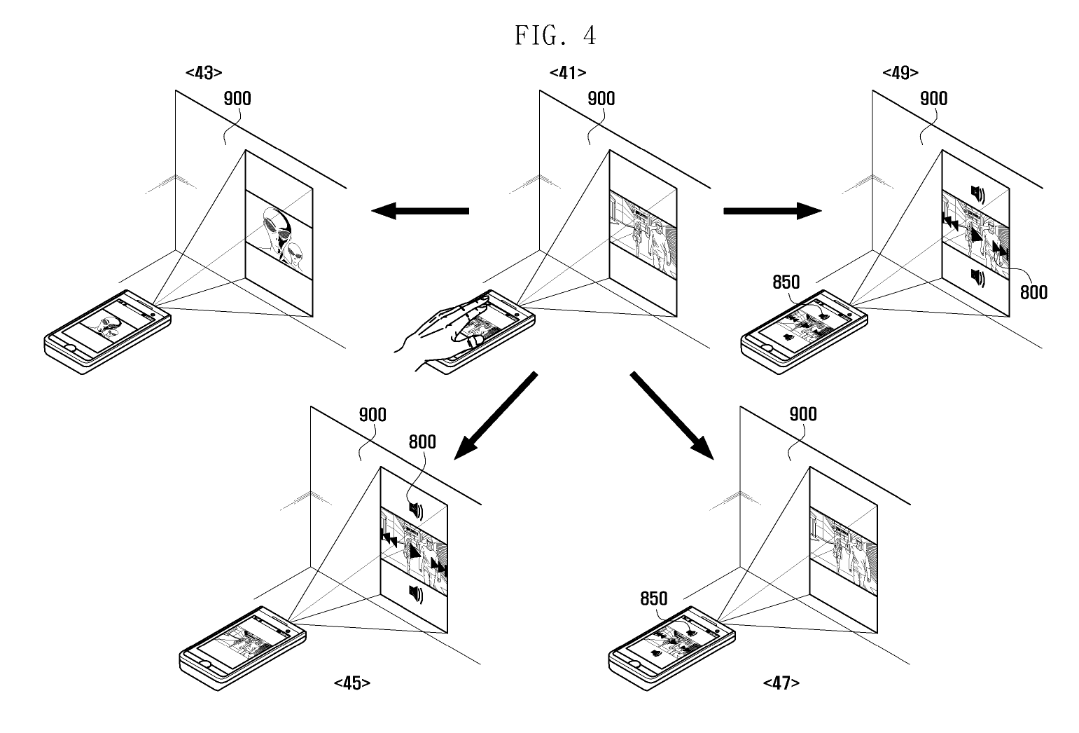

FIG. 4 illustrates views that describe methods for activating a mode and displaying a virtual item in a mobile device, according to an exemplary embodiment of the present invention.

Referring to FIG. 4, diagram 41 shows a state where the mobile device outputs screen data to an external screen 900 via the projector module 300. The external screen 900 refers to a surface on which the projector module 300 projects the screen data. Examples of the external screen 900 are a whiteboard, a wall, a floor, etc. It will be appreciated that the external screen 900 may be all types of objects if they can receive the screen data from the projector module 300 and display it.

While the screen data is being displayed on the external screen 900 as shown in diagram 41, the user makes a gesture to control the screen data. For example, the user may put an object, for example, his/her hand, on the front of the mobile device. In that case, the mobile device can sense the approach of the object via the sensor module 400 implemented with at least one of the proximity sensor, illumination sensor, and camera sensor. When the mobile device detects the object, it identifies preset control information and display information, provides a GUI (i.e., a virtual item) for controlling a corresponding function as show in one of diagrams 43, 45, 47 and 49, and then controls the corresponding function.

Diagram 43 shows an example where the control information is set to omit the display of the virtual item for controlling screen data of a particular application, which is being output to an external screen. In that case, the controller 700 can directly control the function of the screen data, according to the interaction information transferred from the sensor module 400, in a state as shown in diagram 41. That is, if the control information is to omit the display of the virtual item, the controller 700 activates a mode and omits the display of a virtual item according to the mode activation, so that it can directly control an external output function based on the interaction information.

Diagram 45 shows an example where the control information is set to activate a mode and the display information is set to display a virtual item 800 for controlling screen data of a particular application, which is being output, on the screen data that is projected onto the external screen 900, which is called external screen data. In that case, the user can make a gesture in space near the mobile device in order to control a corresponding function, referring to the virtual item 800 displayed onto the external screen data.

When the sensor module 400 transfers first interaction information to the controller 700 after the screen data is externally output, the controller 700 determines whether to activate a mode based on the control information. In addition, the controller 700 can control the output of the virtual item 800 onto the external screen data, based on the display information. When the sensor module 400 transfers new interaction information to the controller 700 after the virtual item 800 is externally output, the controller 700 processes an external output function based on the new interaction information.

Diagram 47 shows an example where the control information is set to activate a mode and the display information is set to display a virtual item 850 for controlling screen data of a particular application, which is being output, on the screen data that is displayed on the display unit 100, which is called internal screen data. In that case, the user can make a gesture in space near the mobile device in order to control a corresponding function, referring to the virtual item 850 displayed on the internal screen data.

When the sensor module 400 transfers first interaction information to the controller 700 after the screen data is externally output, the controller 700 determines whether to activate a mode based on the control information. In addition, the controller 700 can control the output of the virtual item 850 onto the internal screen data, based on the display information. When the sensor module 400 transfers new interaction information to the controller 700 after the virtual item 850 is externally output, the controller 700 processes an external output function based on the new interaction information.

Diagram 49 shows an example where the control information is set to activate a mode and the display information is set to display virtual items 800 and 850 for controlling screen data of a particular application, which are being output, on both the external screen data and the internal screen data. In that case, the user can make a gesture in space near the mobile device in order to control a corresponding function, referring to one of the virtual items 800 and 850 displayed onto the external screen data and the internal screen data, respectively.

When the sensor module 400 transfers first interaction information to the controller 700 after the screen data is externally output, the controller 700 determines whether to activate a mode based on the control information. In addition, the controller 700 can control simultaneous output of the virtual items 800 and 850 onto the external screen data and the internal screen data, based on the display information. When the sensor module 400 transfers new interaction information to the controller 700 after the virtual items 800 and 850 are externally output, the controller 700 processes an external output function based on the new interaction information.

As described above, referring to FIG. 4, the method according to an exemplary embodiment of the present invention can omit the output of a virtual item for controlling the output screen data according to preset optional information, or can display the screen data on at least one of the internal screen data and the external screen data. In particular, when omitting output of the virtual item, the method can directly control a corresponding function according to first received interaction information. When displaying the virtual item, the method activates a mode according to first received interaction information, controls display of the virtual item on at least one of the internal screen data and the external screen data, and then controls a corresponding function according to next received interaction information.

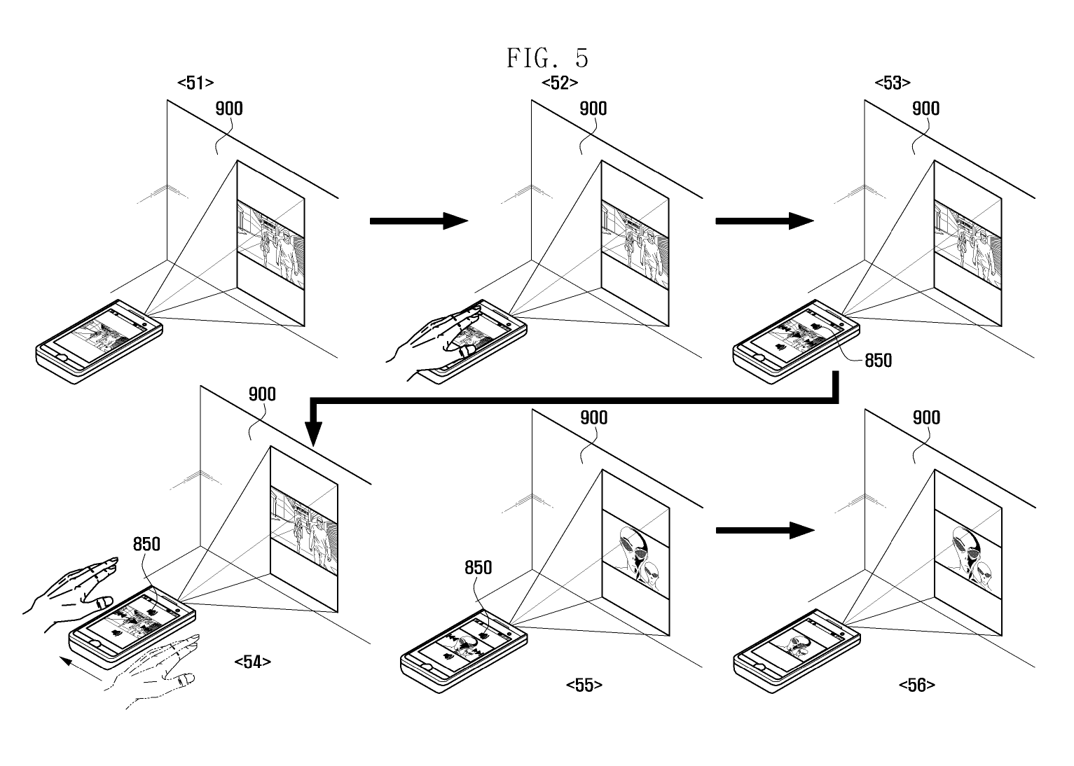

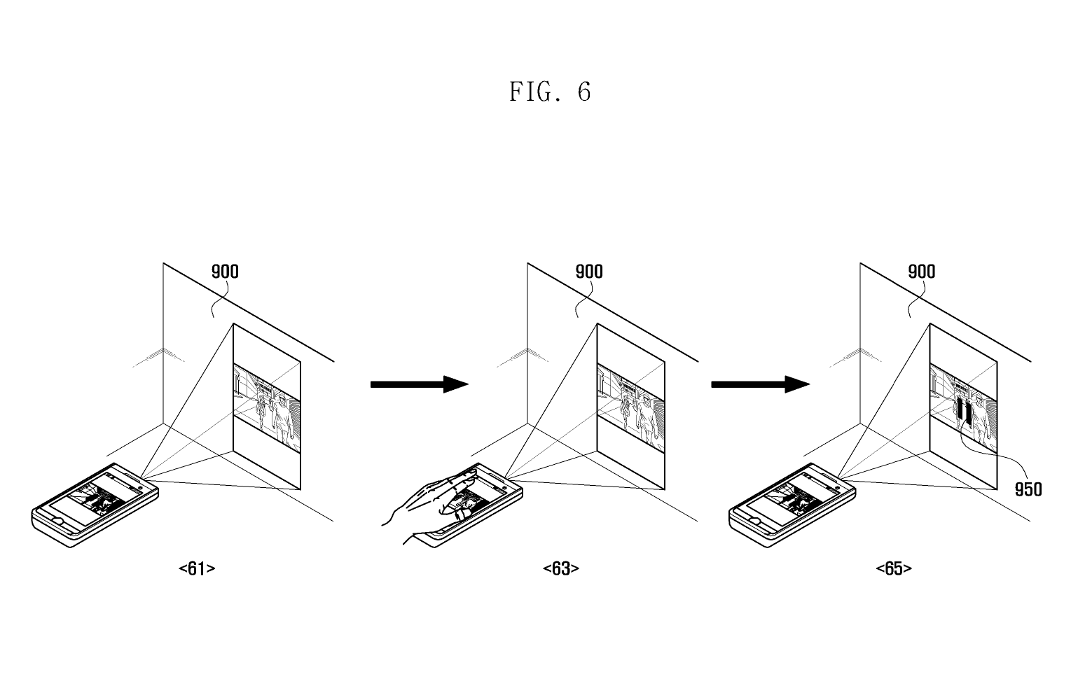

The following description explains methods for controlling an external output function after activating a mode and without activating a mode, with reference to FIGS. 5 and 6, respectively.

FIG. 5 illustrates views that describe a method for controlling an external output function of a mobile device, after activating a mode, according to an exemplary embodiment of the present invention.

FIG. 5 shows an exemplary embodiment where a mode is activated in a state shown in FIG. 4, and then a virtual item for controlling an external output function is displayed on the internal screen data. It should be, however, understood that the invention is not limited to the exemplary embodiment. It will be noted that there may be many modifications from the exemplary embodiments without departing from the spirit or scope of the invention,

Referring to FIG. 5, diagram 51 shows a state where the mobile device outputs screen data of a particular application to an external screen 900 via the projector module 300, according to the external output function. Simultaneously, the screen data of a particular application may also be displayed on the display unit 100. On the contrary, the screen data of a particular application might not be displayed on the display unit 100. FIG. 5 shows an example where the screen data is displayed on both the external screen 900 and the display unit 100.

The screen data may be dynamic screen data reproduced by a playback application (e.g., a moving image playback application, a digital broadcast playback application, etc.). The screen data may also be static screen data displayed by a viewer application (e.g., a text viewer application, an image viewer application, etc.).

While the screen data is being output onto the external screen 900 as shown in diagram 51, the user can perform a gesture for controlling a function corresponding to the screen data as shown in diagram 52. In that case, the sensor module 400 detects an object for the gesture, creates interaction information based on the gesture, and transfers the interaction information to the controller 700. The controller 700 displays a virtual item 850 for controlling an external output function on the internal screen data, according to preset display information, as shown in diagram 53.

After activating the mode for controlling an external output function and displaying the virtual item as shown in diagram 53, the user can perform a gesture for controlling a corresponding function as shown in diagram 54. In that case, the sensor module 400 detects an object for the gesture, creates interaction information based on the gesture, and transfers the interaction information to the controller 700. The controller 700 identifies a mapped function according to the interaction information and controls the identified function.

For example, as shown in diagram 55, the controller 700 can switch screen data by controlling a corresponding function based on the interaction information. When the screen data is created as a particular moving image is played back and the interaction information is to control a FF function, the controller 700 controls the FF function in a preset section of the screen data, thereby switching the screen data. In addition, according to types of applications, the controller 700 can perform various types of functions, such as a channel switch, increase/decrease of volume, pause, REW, zoom in/out, page switch, screen switch, slide show, scroll, navigation, etc.

Although it is omitted in FIG. 5, the controller 700 can also display execution information reporting that a corresponding function is executed when a particular function is controlled according to interaction information. For example, the controller 700 displays execution information, such as an icon, text, etc., on at least one of the internal screen data and the external screen data, for a preset time period or during the function control operation. The execution information may be displayed on the internal screen data or the external screen data until a preset time period has elapsed, and then removed therefrom. In addition, the execution information may be displayed on the internal screen data or the external screen data before a corresponding function is released, and then removed therefrom.

After controlling a particular function for the external output and a corresponding function as shown in diagram 54, the user can continue viewing corresponding screen data. When the controller 700 does not receive new interaction information until a preset time period has elapsed, it can remove the virtual item 850 from the internal screen data as shown in diagram 56. Alternatively, the controller 700 can also remove the virtual item from the internal screen data by performing a user's gesture or touching a preset short-cut icon.

FIG. 6 illustrates views that describe a method for controlling an external output of a mobile device, without activating a mode, according to an exemplary embodiment of the present invention.

Referring to FIG. 6, diagram 61 shows a state where the mobile device outputs screen data of a particular application to an external screen 900 via the projector module 300, according to the external output function. Simultaneously, the screen data of a particular application may also be displayed on the display unit 100. On the contrary, the screen data of a particular application might not be displayed on the display unit 100. FIG. 6 shows an example where the screen data is displayed on both the external screen 900 and the display unit 100.

The screen data may be dynamic screen data reproduced by a playback application (e.g., a moving image playback application, a digital broadcast playback application, etc.). The screen data may also be static screen data displayed by a viewer application (e.g., a text viewer application, an image viewer application, etc.).

While the screen data is being output onto the external screen 900 as shown in diagram 61, the user can perform a gesture for controlling a function corresponding to the screen data as shown in diagram 63. In that case, the sensor module 400 detects an object for the gesture, creates interaction information based on the gesture, and transfers the interaction information to the controller 700. The controller 700 identifies a mapped function according to the interaction information and controls the identified function. For example, the controller 700 can perform a corresponding function based on the interaction information, with respect to the screen data that is being output, as shown in diagram 65. For example, when the screen data is created as a particular moving image is played back and the interaction information is to control a pause function, the controller 700 can pause the playback of the screen data by controlling the pause function. In addition, according to types of applications, the controller 700 can perform various types of functions, such as a channel switch, increase/decrease of volume, REW, FF, zoom in/out, page switch, screen switch, slide show, scroll, navigation, etc.

The controller 700 can display execution information 950 reporting that a corresponding function is executed when a particular function is controlled according to interaction information. For example, the controller 700 displays execution information 950 reporting that playback is paused, such as an icon, text, etc., on at least one of the internal screen data and the external screen data, when a corresponding function (e.g., a pause function) is controlled according to the interaction information.

The execution information 950 may be displayed on the internal screen data or the external screen data until a preset time period has elapsed, and then removed therefrom. The execution information 950 may be displayed on the internal screen data or the external screen data before a corresponding function is released, and then removed therefrom. Alternatively, the controller 700 can also remove the execution information 950 from the internal screen data or the external screen data by performing a user's gesture or touching a preset shortcut icon.

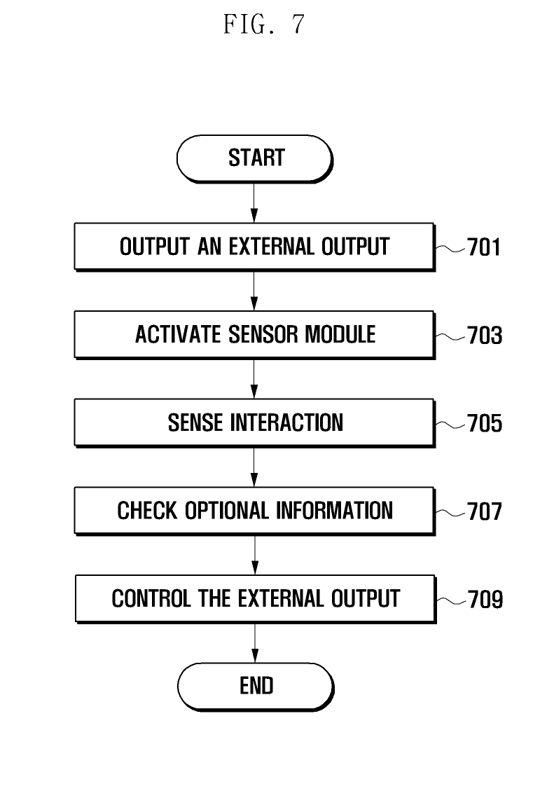

FIG. 7 illustrates a flowchart that describes a method for controlling an external output of a mobile device, by detecting a user's gesture, according to an exemplary embodiment of the present invention.

Referring to FIG. 7, when the user operates an input unit related to a projection function of the mobile device, the mobile device activates the projection function. The controller 700 activates the projector module 300 according to the user's request, so that the projector module 300 outputs screen data of a particular application onto an external screen 900 at step 701. Before the projector module 300 is driven, the mobile device may be displaying particular screen data of an application corresponding to a use's request on the display unit 100.

After that, the controller 700 drives a sensor module 400 at step 703. The controller 700 can control an automatic activation of the sensor module 400 when the projector module 300 is driven. Alternatively, the controller 700 can control a passive activation of the sensor module 400 when the user inputs a signal.

The controller 700 detects an interaction according to a user's gesture via the sensor module 400 while the screen data is being externally output at step 705. That is, the user can create a gesture for controlling an external output function near the mobile device. For example, the user can create a gesture in such a way that an object, for example, his/her hand, comes close to the front of the mobile device postured as shown in FIG. 1 and makes a motion thereon. In that case, the sensor module 400 detects the object according to the user's gesture performed near the mobile device. After that, the sensor module 400 transfers an interaction corresponding to the user's gesture to the controller 700. Therefore, the controller 700 can determine that an interaction has occurred.

When the controller 700 detects the interaction created by the user, it can check preset optional information for controlling an external output at step 707. The optional information may include, for example, control information for determining whether to control a function according to an interaction without a mode activation procedure, or without displaying a virtual item, when the interaction occurs during the external output; display information for setting a display mode of a virtual item for controlling a function of the screen data that is output to an external screen according to the execution of a particular application; mapping information regarding virtual items mapped by applications; and function information corresponding to mapping information by applications.

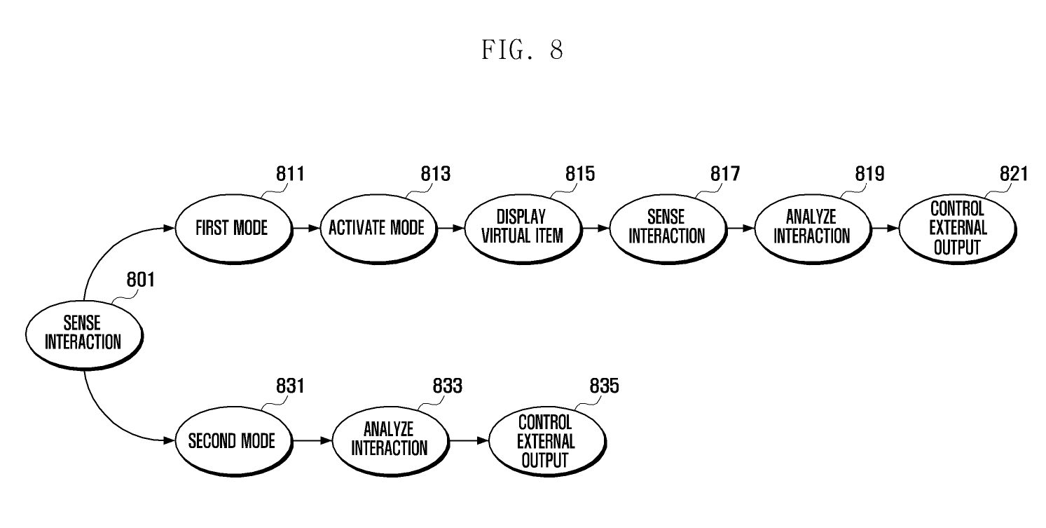

After that, the controller 700 controls a function corresponding to the interaction based on the optional information at step 709. When the controller 700 controls an external output function according to the optional information, without activating a mode, it can directly control a function corresponding to the interaction. Alternatively, the controller 700 can also activate a mode, according to the interaction, based on the optional information, and can then control an external output function corresponding to another interaction newly created after the mode is activated. A method for controlling an external output function based on preset optional information is described in detail with reference to FIG. 8.

FIG. 8 illustrates views that describe a method for controlling an external output, based on a mode set in a mobile device, according to an exemplary embodiment of the present invention.

Referring to FIG. 8, when the controller 700 detects an interaction transferred from the sensor module 400 at step 801, it can check preset optional information. For the sake of convenience, the optional information is described in this example with respect to a first mode where a mode activation is performed according to an initially detected interaction and a second mode where an external output is controlled according to an initially detected interaction without mode activation. This corresponds to the description referring to FIG. 4.

When the controller 700 is operated in the first mode according to the optional information at step 811, it activates a mode for controlling an external output function according to the detected interaction at step 813. The controller 700 outputs a GUI-based virtual item on at least one of the internal screen data and the external screen data according to the display information in the optional information at step 815. After outputting the virtual item at step 815, the controller 700 detects a new interaction transferred from the sensor module 400 at step 817. In that case, the controller 700 analyzes the new interaction at step 819. That is, the controller 700 analyzes the new interaction which function it serves to control, based on the mapping information in the optional information. After that, the controller 700 controls a function corresponding to an external output according to the new interaction at step 821. This corresponds to the description referring to FIG. 5.

On the other hand, when the controller 700 is operated in the second mode according to the optional information at step 831, it analyzes the interaction transferred from the sensor module 400 at step 833. That is, the controller 700 analyzes the interaction which function it serves to control, based on the mapping information in the optional information. After that, the controller 700 directly controls a function corresponding to an external output according to the interaction at step 835. This corresponds to the description referring to FIG. 6.

As described above, the method and system, according to exemplary embodiments of the present invention, can allow the user to more intuitively control a function for screen data that is being output, by only his/her simple gesture, via a sensor module according to an environment for performing an external output operation. The method and system according to exemplary embodiments of the present invention can allow the user to control an external output function by only his/her simple gesture without contacting the mobile device, so that the screen data can be projected to an external screen without being displaced or varying its location.

In addition, the method and system, according to exemplary embodiments of the present invention, can also allow the user to control various functions for screen data that is being output on an external screen, by only his/her simple gesture performed near the mobile device, via a sensor module, in an environment such as a dark place or a bright place, where the various functions may include a channel switch, screen switch, page switch, increase/decrease of volume, FF, REW, pause, playback, image switch, slide show, etc.

The above-described methods according to exemplary embodiments of the present invention can be implemented in hardware or as software or computer code that can be stored in a computer-readable recording medium such as a Compact Disc (CD) ROM, a RAM, a floppy disk, a hard disk, a magneto-optical disk, or downloaded over a network, so that the methods described herein can be rendered in such software using a general purpose computer, or a special processor or in programmable or dedicated hardware, such as an Application Specific Integrated Circuit (ASIC) or a Field Programmable Gate Array (FPGA). As would be understood by those skilled in the art, the computer, the processor or the programmable hardware include memory components, e.g., a RAM, a ROM, a Flash, and the like, that may store or receive software or computer code that when accessed and executed by the computer, processor or hardware, implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method for controlling a mobile device equipped with a projector module, the method comprising:
outputting an external output comprising external screen data from the projector module;
activating a sensor module;
detecting, by the sensor module, an interaction according to a user's gesture; and
controlling the external output, based on the detected interaction.

2. The method of claim 1, wherein the detecting of the interaction comprises:
checking preset optional information, with respect to an external output function of the mobile device when the sensor module detects the interaction.

3. The method of claim 2, wherein the checking of the preset optional information comprises:
determining whether a mode is activated, according to the preset optional information.

4. The method of claim 3, wherein the controlling of the external output comprises:
outputting, when a mode is activated, a virtual item according to a first interaction; and
controlling the external output according to a second interaction transferred from the sensor module, after outputting the virtual item.

5. The method of claim 4, wherein the outputting of the virtual item comprises:
checking display information from among the optional information, where the display information sets a displaying mode of the virtual item to control a function of screen data; and
outputting the virtual item to at least one of internal screen data and the external screen data, corresponding to the display information.

6. The method of claim 1, wherein the controlling of the external output comprises:
controlling, when a mode is deactivated, the external output, according to the interaction, without outputting a virtual item.

7. The method of claim 2, wherein the activating of the sensor module comprises:
activating the sensor module when the external output function is performed or according to a user's selection.

8. A mobile device comprising:
a projector module for outputting screen data of the mobile device to an external screen;
a storage unit for storing optional information for an external output function of the mobile device;
a sensor module for detecting a user's gesture, performed in proximity to the mobile device, and for providing an interaction corresponding to the user's gesture; and
a controller for controlling a function, related to an external output of the projector module, and for controlling, when detecting the interaction transferred from the sensor module while the external output is being output, the external output function according to the optional information.

9. The mobile device of claim 8, wherein the optional information comprises:
control information for determining whether to control a function that is related to an interaction transferred while the external output is being output; and
display information representing a display mode of a virtual item for controlling a function of screen data output according to an execution of a particular application.

10. The mobile device of claim 8, wherein the sensor module detects movement direction, movement speed, and shape of a user's gesture, creates interaction information according to the user's gesture performed in proximity to the mobile device, and outputs the interaction information to the controller.

11. The mobile device of claim 10, wherein the sensor module comprises at least one of the following:
a proximity detecting module for transferring the interaction information to the controller when the projector module outputs the external output; and
a camera module for transferring the interaction information, performed in proximity to the mobile device, to the controller when the projector module outputs the external output.

12. The mobile device of claim 11, wherein the proximity detecting module includes at least one of a proximity sensor and an illumination sensor.

13. The mobile device of claim 12, wherein the proximity sensor comprises a plurality of proximity sensors oriented in mutually different directions.

14. The mobile device of claim 12, wherein the illumination sensor comprises a plurality of illumination sensors oriented in mutually different directions.

15. The mobile device of claim 11, wherein the camera module comprises a plurality of cameras oriented in mutually different directions.

16. The mobile device of claim 9, wherein the controller receives an interaction from the sensor module while the projector module is outputting an external output and determines whether to activate a mode according to the control information.

17. The mobile device of claim 16, wherein the controller outputs a virtual item to at least one of internal screen data and external screen data, according to the display information, when the mode is activated, and controls the external output according to a new interaction transferred from the sensor module.

18. The mobile device of claim 16, wherein the controller controls the external output according to the interaction transferred from the sensor module, without outputting a virtual item, when a mode is deactivated.
